(19) United States
(12) Patent Application Publication
(10) Pub. No.: US 2016/0032984 A1
(43) Pub. Date: Feb. 4, 2016

(54) TRIPOD CONSTANT VELOCITY JOINT

(71) Applicant: JTEKT CORPORATION, Osaka-shi (JP)

(72) Inventor: Keishi Kobata, Anjo-shi (JP)

(73) Assignee: JTEKT CORPORATION, Osaka-shi (JP)

(21) Appl. No.: 14/813,543

(22) Filed: Jul. 30, 2015

(30) Foreign Application Priority Data
Aug. 1, 2014 (JP) 2014-157870
Aug. 1, 2014 (JP) 2014-157871

(51) Int. Cl. F16D 3/205

(52) U.S. Cl. CPC F16D 3/2055; F16D 2003/2023

(57) ABSTRACT

A tripod constant velocity joint includes, an outer race, a tripod, an inside member, a plurality of rolling elements, and a holding member. The inside member includes a fitted part having a non-cylindrical outer peripheral surface, the holding member includes a fitting part that has a non-cylindrical inner peripheral surface and is fitted to the fitted part, and the holding member is unable to rotate relative to the inside member as the fitted part and the fitting part are fitted to each other.

### INCORPORATION BY REFERENCE

The disclosure of Japanese Patent Application No. 2014-157870 and 2014-157871 filed on Aug. 1, 2014 including the specification, drawings and abstract is incorporated herein by reference in its entirety.

### BACKGROUND OF THE INVENTION

1. Field of the Invention

The invention relates to a tripod constant velocity joint.

2. Description of Related Art

A tripod constant velocity joint described in Japanese Patent Application Publication No. 2014-88889 (JP 2014-88889 A) includes an tubular outer race, in which three raceway grooves are formed in an inner peripheral surface, a tripod having three tripod shaft parts inserted in the raceway grooves, respectively, outer rollers inserted in the raceway grooves, respectively, inner rollers fitted onto the tripod shaft parts, respectively, and rolling elements (needles) interposed between the outer rollers and the inner rollers so as to roll. In this structure, when power is transmitted between the tripod and the outer race in a state where the tripod is tilted so that a joint angle, which is a relative angle between the tripod and the outer race, becomes a given angle, the outer roller and the raceway groove could be in contact with each other not only on a power transmission side but also on the opposite side of the power transmission side. Therefore, sliding friction happens in a portion of the outer roller, which is in contact with the raceway groove on the opposite side of the power transmission side, and this could cause large resistance.

Further, a tripod constant velocity joint described in Published Japanese Translation of PCT Application No. 7-501126 (JP-H07-501126) is structured as follows. The foregoing outer rollers are removed so that the shaft-shaped rolling element rolls in a raceway groove, and the rolling element is supported by a holding member so as to be able to circulate along an outer periphery of a ring-shaped inside member. Thus, the rolling element, which is located on the opposite side of the power transmission side, has small friction force against the raceway groove. Therefore, resistance due to sliding friction between the rolling element and the raceway groove is reduced greatly.

### SUMMARY OF THE INVENTION

In the constant velocity joint described in JP-H07-501126, since the inside member is provided so as not to rotate relative to an outer race, the holding member is also provided so as not to rotate relative to the inside member. However, the holding member is structured so as not to rotate relative to the inside member through rolling elements. This means that the holding member is not able to rotate relative to the inside member because an inner periphery side surface of a wall part (a cover) that is formed integrally with the holding member so as to cover some of the plurality of rolling elements are abutted on outer periphery sides of the rolling elements arranged on the outer periphery side of the inside member. Since the inside member, the rolling elements, and the wall part are arranged in line towards a radially outer side of the inside member, the holding member becomes large and heavy, thereby causing an increase in size and weight of the constant velocity joint.

The invention provides a tripod constant velocity joint that is able to achieve downsizing and weight reduction while employing a rolling element circulation type that reduces resistance caused by sliding on a raceway groove on the opposite side of a power transmission side.

A tripod constant velocity joint according to an aspect of the invention includes an outer race having a tubular shape, in which a plurality of raceway grooves extending in a rotation axis direction of the outer race are formed in an inner peripheral surface of the outer race, a tripod including a boss part coupled with a shaft, and a plurality of tripod shaft parts provided so as to extend to a radially outer side of the boss part from an outer peripheral surface of the boss part, an inside member that is formed into a ring shape and provided in an outer periphery of the shaft part of the tripod so as to be able to tilt with respect to the shaft part of the tripod, a plurality of rolling elements that are provided in an outer periphery of the inside member so as to be able to circulate, and are provided so as to be able to roll along a side surface of the raceway groove, and a holding member that restricts the rolling elements from moving with respect to the inside member in an axial direction of the inside member and also restricts the rolling elements from moving with respect to the inside member to a radially outer side of the inside member. The inside member includes a fitted part having a non-cylindrical outer peripheral surface. The holding member includes a fitting part that has a non-cylindrical inner peripheral surface and is fitted to the fitted part. The holding member is unable to rotate relative to the inside member as the fitted part and the fitting part are fitted to each other.

The tripod constant velocity joint according to the above aspect is a so-called rolling element circulation type. Thus, the rolling elements, which are located on the opposite side of a power transmission side, have small friction force against the raceway grooves, and resistance due to sliding friction between the rolling elements and the raceway grooves is greatly reduced. Since the fitting part of the holding member, which has the non-cylindrical inner peripheral surface, and the fitted part of the inside member, which has the non-cylindrical outer peripheral surface, are fitted to each other, the holding member is prevented from rotating relative to the inside member while holding the rolling elements in a favorable fashion. This means that rotation of the holding member relative to the inside member is suppressed directly. Therefore, unlike the prior art, it is not necessary to provide a wall part (a cover) in a holding member and abut an inner periphery side surface of the wall part on an outer periphery side of the rolling element in order to disable the holding member from rotating relative to the inside member. Hence, the wall part of the holding member is not arranged in line with the inside member and the rolling elements towards a radially outer side of the inside member. Therefore, the size and weight of the holding member are reduced, thereby realizing downsizing and weight reduction of the constant velocity joint.

The tripod constant velocity joint may also include a snap ring that restricts the holding member from moving in the axial direction of the inside member. The inside member may have an arc groove on the outer peripheral surface, to which the snap ring is fitted. The non-cylindrical outer peripheral surface of the fitted part of the inside member may have an inside member arc part. The non-cylindrical inner peripheral surface of the fitting part of the holding member may have a holding member arc part corresponding to the inside member arc part of the fitted part. The arc groove and the inside member arc part may be formed coaxially with each other.

As stated above, since the arc groove and the inside member arc part are coaxial with each other, it is necessary to set a material for the inside member in a lathe only once, and then the arc groove and the inside member arc part are turned without a set-up change thereafter. Thus, processing cost is reduced. Further, since the snap ring is provided, the holding member is fixed for retention more securely, thereby improving reliability.

An inner peripheral surface of the snap ring may have a cylinder shape, and the arc groove of the inside member may be provided in a portion in a phase of the outer peripheral surface of the inside member in the circumferential direction. The above-mentioned portion in the phase is different from a portion in a phase that faces the side surface of the raceway groove.

As stated above, although the cylinder-shaped snap ring is fitted, the groove in the inside member, to which the snap ring is fitted, is not provided in the entire circumference, and is provided as the arc groove only in the portion in the phase that is different from the portion in the phase that faces the side surfaces of the raceway groove. Therefore, of the width of the inside member, the width of the portion in the phase where the arc groove is not provided is smaller than that in the case where the groove is provided in the entire circumference. Therefore, the size of the inside member is reduced.

The non-cylindrical outer peripheral surface of the fitted part of the inside member may have a flat surface part, the inside member may have a flat surface-shaped rolling surface that allows the rolling elements to roll, and the flat surface part of the fitted part and the flat surface-shaped rolling surface may be formed on a same plane. Thus, it is possible to form the flat surface part of the inside member, and the flat surface-shaped rolling surface at the same time by simple flat surface grinding, thereby reducing costs.

The flat surface part of the fitted part of the inside member, and the flat surface-shaped rolling surface of the inside member may be surface that face the side surfaces of the raceway groove. Thus, the flat surface part of the inside member and the flat surface-shaped rolling surface also work as transmission surfaces that transmit rotational driving force of the tripod shaft to the side surface of the raceway groove through the rolling elements. Therefore, it is not necessary to provide an additional transmission surface, and it is thus possible to obtain the transmission surface with good accuracy at low cost.

The inside member may be formed into a rectangular parallelepiped shape with two opposing pairs of parallel flat surfaces in an outer periphery, and the two pairs of flat surfaces includes a pair of flat surfaces on long sides where sides in the circumferential direction are longer, and a pair of flat surfaces on short sides where sides in the circumferential direction are shorter than the sides of the flat surfaces on the long sides. A portion of the fitted part of the inside member, which is engaged with the fitting part of the holding member in the circumferential direction, may be provided in the flat surfaces on the long sides of the inside member, and the flat surfaces on the long sides are surfaces facing the side surfaces of the raceway groove.

As stated above, the portion to be engaged with the fitted part of the holding member in the circumferential direction is provided in the fitting part in the flat surface on the long side of the inside member. Therefore, the portion to be engaged becomes longer compared to a case where a portion engaged is provided in the flat surface on the short side. Hence, the rotation of the holding member relative to the inside member in the circumferential direction is restricted highly accurately.

The pair of flat surfaces on the long sides of the inside member having the rectangular parallelepiped shape may be ground surfaces, and the pair of flat surfaces on the short sides may be non-ground surfaces. Thus, the inside member is obtained at low cost.

It is also necessary to prevent the inside member from being inserted into the raceway groove in a direction in which the flat surfaces, which are the non-ground surfaces, face the side surfaces of the raceway groove, in other words, a direction in which the flat surfaces, which are the non-ground flat surfaces, become the power transmission surfaces. The inside member has the rectangular parallelepiped shape in which the flat surfaces on the long sides are ground surfaces, and the flat surfaces on the short sides are non-ground surfaces. This means that, even if an operator tries to insert the inside member to the raceway groove so that the flat surface on the short sides face the side surfaces of the raceway groove, it is not possible to insert the inside member in the raceway groove. Therefore, it is ensured that the inside member is assembled to the raceway groove so that the long sides, which are the ground surfaces, face the side surfaces of the raceway groove.

The holding member may be provided on both end sides of the inside member in the axial direction. As stated above, the tripod constant velocity joint includes the simple and inexpensive holding members on both ends of the inside member, and the holding members on both sides hold the rolling elements. Therefore, the shape of the inside member becomes simple, thereby reducing costs for the inside member.

The holding member may be formed into a ring plate shape, and a rolling element abutment part that abuts on an end part of the rolling element is provided in an outer peripheral part of the holding member. A plate thickness of the fitting part of the holding member may be larger than at least a part of a plate thickness of the rolling element abutment part.

Thus, the rolling elements located on the opposite side of the power transmission side have small friction force against the raceway groove, and resistance due to sliding friction between the rolling elements and the raceway groove is greatly reduced. In addition, the fitting part of the holding member is formed so that the plate thickness becomes larger than the plate thickness of at least a part of the rolling element abutment part. Therefore, the fitting part is fitted to the inside member while ensuring strength by the large plate thickness, and the weight of the rolling element abutment part is reduced. Therefore, the weight of the holding member is reduced, thereby reducing the weight of the constant velocity joint.

The rolling element may have a shaft shape, and include a cylindrical part, and the end part projecting from an end surface of the cylindrical part in a central axis direction of the cylindrical part. The rolling element abutment part of the holding member may include an axial movement restricting part that is formed to the radially outer side of the inside member from the fitting part of the holding member, and has an axially restricting surface that restricts the rolling element from moving with respect to the inside member in the axial direction of the inside member by abutting on a distal end of the end part of the rolling element. A maximum outer diameter of the cylindrical part of the rolling element in the axial direction of the inside member is larger than an outer diameter of the end part, and a plate thickness of the holding member increases from the axially restricting surface towards the fitting part side in a direction to a center part of the rolling element.

As stated above, the holding member is formed so that the plate thickness increases from the axially restricting surface towards the fitting part side in a direction to the center part side of the rolling element. In short, the plate thickness of the fitting part increases towards a gap made by an outer diameter difference between an outer diameter of the end part of the shaft-shaped rolling element and the maximum outer diameter of the cylindrical part. Therefore, compared to the case where the plate thickness of the fitting part becomes large towards the opposite side of the rolling element, the length of the inside member and the fitting part in the axial direction of the inside member is shortened when the inside member and the fitting part are assembled. Thus, the size of the tripod constant velocity joint is reduced.

The holding member for the rolling element may include a radial movement restricting part that is formed by bending an outer peripheral part of the axial movement restricting part in a direction to the rolling element, and restricts the rolling element from moving to the radially outer side of the inside member. Thus, the weight of the holding member is reduced while holding the rolling elements favorably.

A rib part, which expands to a radially outer side of the holding member, may be provided in an end part of the radial movement restricting part. Thus, effects similar to those of the foregoing structures are obtained.

The inside member may have a snap ring groove in the outer peripheral surface, and a snap ring may be fitted to the snap ring groove. The snap ring abuts on a surface of the axial movement restricting part on the opposite side of the axially restricting surface, and restricts the holding member from moving in the axial direction of the inside member. Thus, even if the rolling element moves in the axial direction of the inside member and presses the axially restricting surface, the snap ring receives pressure force from the rolling element. Therefore, the snap ring favorably holds the rolling element as well as the holding member.

The snap ring may cover a center axis of the cylindrical part of at least one of the rolling elements out of the plurality of rolling elements arranged so as to face the side surface of the raceway groove. As stated above, the snap ring is provided at a position where the snap ring covers the axis of at least one of the rolling elements that are arranged so as to face the side surfaces of the raceway groove. This is because, among the plurality of rolling elements, the above-mentioned rolling elements transmit rotational driving force and large force could be applied in the axial direction on the side surfaces of the raceway groove. Thus, even if the rolling element moves in the axial direction of the inside member and presses the axial movement restricting part of the holding member with large force, the snap ring, which is provided in the axial movement restricting part on the opposite side of the rolling element, is able to receive the pressure force of the rolling element. Therefore, the snap ring holds the rolling element favorably in collaboration with the holding member. It is thus possible to reduce the plate thickness of the axial movement restricting part further, and the weight of the holding member is thus reduced further.

The fitting part of the holding member may be formed from a plurality of arc surfaces, and the plurality of arc surfaces may be coaxial with each other. Since the plurality of arc surfaces are coaxial with each other, it is necessary to set a material for the inside member in a lathe only once, and then the arc surfaces are turned respectively without a set-up change thereafter. As a result, processing cost for the holding member, and the inside member, to which the holding member is fitted, is reduced.

The holding member may be formed by pressing a plate member, and the fitting part of the holding member may be a shear plane of pressing. Thus, the holding member becomes inexpensive.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a constant velocity joint 1, showing a state in which an outer race 10 is cut in an axial direction;

FIG. 2 is a sectional view orthogonal to a rotation axis of an outer race, showing a state where a joint angle of a shaft 2 is 0 degree;

FIG. 3 is a top view of a rolling element unit 30;

FIG. 4 is a sectional view taken along the arrows 4-4 in FIG. 3;

FIG. 5 is a top view of an inside member 31;

FIG. 6 is a sectional view taken along the arrows 6-6 in FIG. 5;

FIG. 7 is an enlarged sectional view taken along the arrows 7-7 in FIG. 5;

FIG. 8 is a top view of a holding member 33;

FIG. 9 is a sectional view of the holding member 33, taken along the arrows 9-9;

FIG. 10 is an enlarged view of an area E in FIG. 9;

FIG. 11 is a view explaining the first modified example; and

FIG. 12 is a view explaining the second modified example.

### DETAILED DESCRIPTION OF EMBODIMENTS

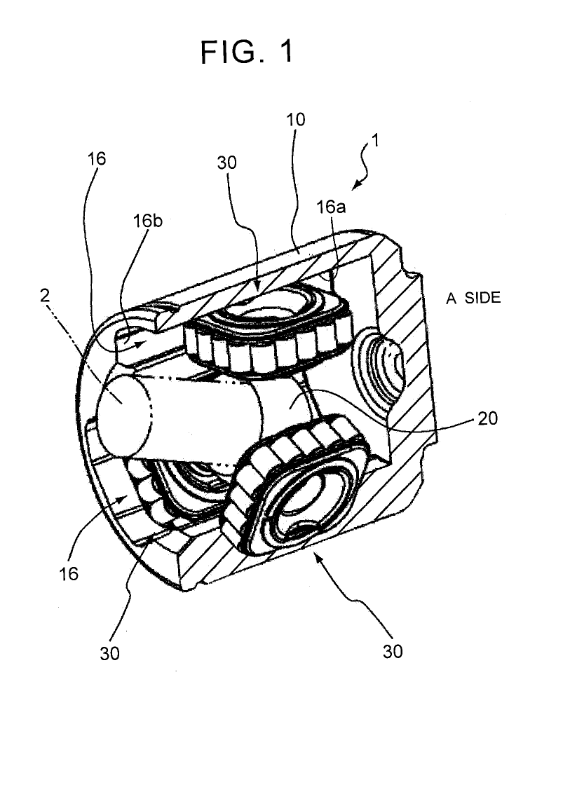

An embodiment, which embodies a tripod constant velocity joint according to the invention (herein after, simply referred to as a “constant velocity joint”), is explained below with reference to FIG. 1 to FIG. 10. Here, the constant velocity joint of this embodiment is explained in an example case where the constant velocity joint is used for coupling of power transmission shafts of a vehicle. For example, this is a case where the constant velocity joint is used in a shaft coupling portion between a shaft part coupled to a differential gear and an intermediate shaft of a drive shaft.

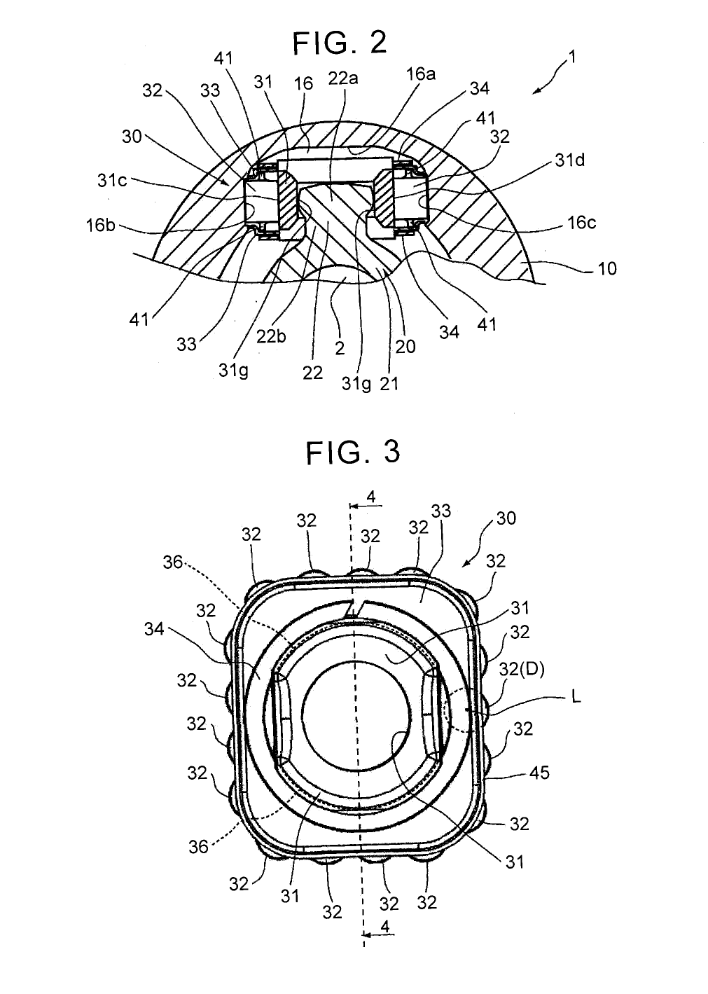

As shown in FIG. 1 and FIG. 2, a constant velocity joint 1 is structured from an outer race 10, a tripod 20, and rolling element units 30. FIG. 1 shows a state where a rotation axis of a shaft 2 depicted in an alternate long and two short dashes line is tilted by a given joint angle with respect to an outer race rotation axis of the outer race 10. FIG. 2 shows a part of a section viewed from an opening side of the outer race 10, and the section is made along a plane that is orthogonal to the outer race rotation axis and passes along an axis of a tripod shaft part 22 included in the tripod 20 described later, in a state where a joint angle between the rotation axis of the shaft 2 and the outer race rotation axis of the outer race 10 is 0 degree.

The outer race 10 is formed into a cylinder shape (for example, a bottomed cylinder shape), and an A side of the outer race 10 in FIG. 1 is coupled to a differential gear (not shown). As shown in FIG. 1 and FIG. 2, in an inner peripheral surface of a cylindrical part of the outer race 10, three (as an example of the number of) raceway grooves 16 are formed at equal intervals in a circumferential direction and extend in a direction of a rotation axis of the outer race 10 (the outer race rotation axis). A section of each of the raceway grooves 16, which is orthogonal to the groove extending direction, is formed into a U-shape that is open towards the center of the rotation axis of the outer race 10. In other words, each of the raceway grooves 16 includes a groove bottom surface 16a formed into a generally flat surface shape, and side surfaces 16b, 16c that are formed into a generally flat surface shape orthogonal to the groove bottom surface 16a and face each other to be in parallel to each other.

The tripod 20 is arranged on an inner side of the outer race 10. The tripod 20 is able to move in a rotation axis direction and tilt with respect to the outer race 10. The tripod 20 is also coupled integrally with the shaft 2. The tripod 20 is provided with a cylindrical boss part 21, which is coupled with the shaft 2, and the three (as an example of the number of) tripod shaft parts 22.

The three tripod shaft parts 22 are provided so as to extend in a standing fashion to a radially outer side of the boss part 21 from a cylindrical outer peripheral surface of the boss part 21 (FIG. 2 shows only one of the tripod shaft parts 22). The tripod shaft parts 22 are formed at equal intervals (at every 120 degrees) in the circumferential direction of the boss part 21. Each of the tripod shaft parts 22 is provided with a spherical convex part 22a formed by making the outer peripheral surface of the tripod shaft part 22 into a spherical convex shape, and a base neck part 22b formed on the boss part 21 side of the spherical convex part 22a. A distal end part of the spherical convex part 22a of each of the tripod shaft parts 22 is inserted into each of the raceway grooves 16 of the outer race 10.

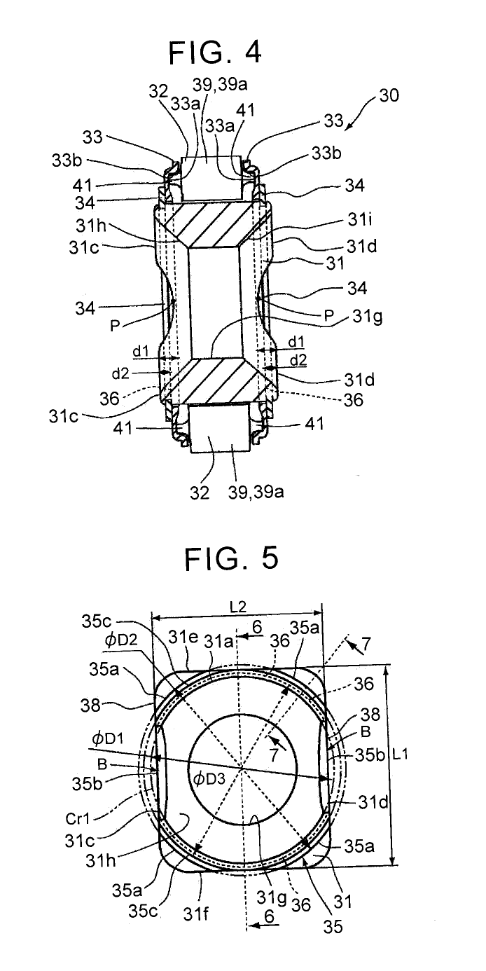

The three rolling element units 30 shown in FIG. 1 to FIG. 4 have a rectangular ring shape as a whole. Each of the rolling element units 30 is able to rotate on an outer periphery side of each of the tripod shaft parts 22, is able to move in an axial direction of each of the tripod shaft parts 22, and is supported so as to tilt with respect to an axis of each of the tripod shaft parts 22. Each of the rolling element units 30 is engaged with each of the tripod shaft parts 22 in a rotation direction of the constant velocity joint 1. This way, each of the rolling element units 30 transmits rotational driving force between each of the tripod shaft parts 22 and the outer race 10. As shown in FIG. 3 and FIG. 4, each of the rolling element units 30 includes an inside member 31, a plurality of rolling elements 32, two holding members 33, 33, and two snap rings 34, 34. In this embodiment, the rolling element 32 has a shaft shape.

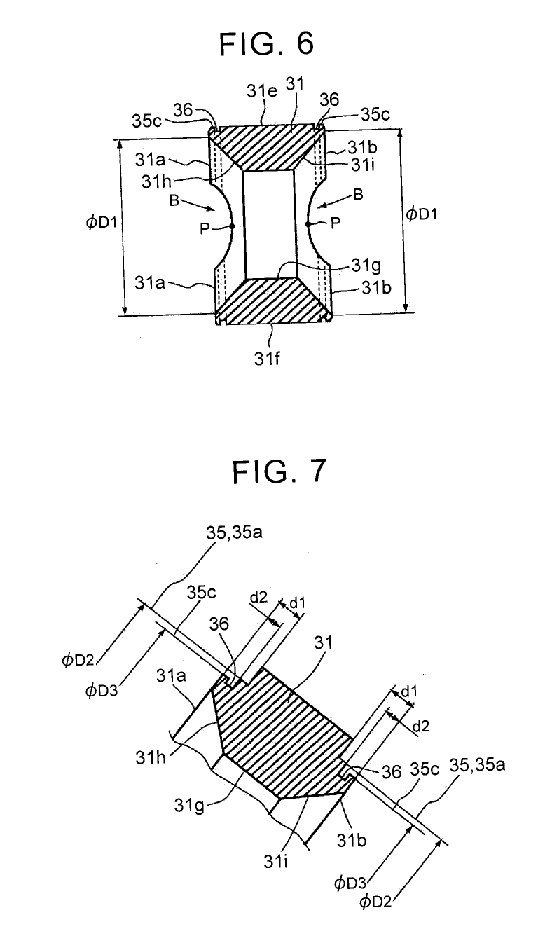

As shown in FIG. 5 and FIG. 6, an outer shape of the inside member 31 is formed into a rectangular parallelepiped shape. The inside member 31 is also formed into a ring shape with a through hole 31g that passes through between both end surfaces 31a, 31b described later. A material for the inside member 31 is formed by, for example, cold forging. Then, only a necessary part of the material for the inside member 31 is processed, thereby forming the inside member 31.

The inside member 31 has the both end surfaces 31a, 31b, side surfaces 31c to 31f that connect the both end surfaces 31a, 31b with each other, and the through hole 31g. The both end surfaces 31a, 31b are a pair of flat surfaces that are opposed to each other in an axial direction of the tripod shaft part 22 in a state where the inside member 31 is assembled to the tripod shaft part 22.

The side surfaces 31c to 31f form two opposing pairs of flat surfaces. Of the two opposing pairs of flat surfaces, the side surfaces 31c, 31d form side surfaces on long sides of the rectangular parallelepiped. Of the two opposing pairs of flat surfaces, the side surfaces 31e, 31f form side surfaces on short sides of the rectangular parallelepiped. In the two opposing pairs of flat surfaces in the side surfaces 31c to 31f on the outer peripheral surfaces of the inside member 31, the side surfaces on the long sides of the rectangular parallelepiped mean a pair of flat surfaces on the side where the sides are longer in a circumferential direction, and the pair of flat surfaces on the sides where the sides are shorter in the circumferential direction is referred to as side surfaces on the short sides. In this embodiment, the side surfaces 31c, 31d, which are the side surfaces on the long sides, are ground surfaces on which grinding is performed. The side surfaces 31e, 31f, which are the side surfaces on the short sides are non-ground surfaces, on which grinding is not performed. Of the side surfaces 31c to 31f included in the inside member 31, the neighboring side surfaces are connected with each other in an arbitrary radian, respectively. The inside member 31 is inserted into each of the raceway grooves 16 of the outer race 10 so that the side surfaces 31c, 31d on the long sides of the rectangular parallelepiped face the side surfaces 16b, 16c of each of the raceway grooves 16, respectively (see FIG. 2).

As shown in FIG. 5 and FIG. 6, the through hole 31g is provided in center parts of the both end surfaces 31a, 31b so as to go through between the both end surfaces 31a, 31b. Tapered surfaces 31h, 31i are provided between the through hole 31g and the both end surfaces 31a, 31b, respectively. Each of the tapered surfaces 31h, 31i is formed so as to extend at a given taper angle towards an axis of the through hole 31g from circumferences of virtual circles Cr1 provided on the both end surfaces 31a, 31b, respectively, about the axis of the through hole 31g. The diameter of the virtual circles Cr1 is φD1. The diameter φD1 of each of the virtual circles Cr1 is equal to or smaller than a length L1 of the long sides of the rectangular parallelepiped (the inside member 31), and is larger than a length L2 of the short sides. Thus, as shown in an areas B in FIG. 6, in the side surfaces 31c, 31d on the long sides of the inside member 31, parts where the tapered surfaces 31h, 31i and the side surfaces 31c, 31d intersect with each other, respectively, have curved shapes dented from the sides of the both end surfaces 31a, 31b, respectively.

The spherical convex part 22a of the tripod shaft part 22 is inserted into the through hole 31g. Therefore, the axis of the through hole 31g of the inside member 31 is able to tilt with respect to the axis of the tripod shaft part 22. At this time, each of the foregoing tapered surfaces 31h, 31i is provided so that the tripod shaft part 22 or the boss part 21 does not come into contact with the inside member 31 when each of the tripod shaft parts 22 tilts by a given joint angle with respect to the inside member 31. Therefore, it is only necessary to set the given angles of the tapered surfaces 31h, 31i arbitrarily to make it possible to prevent interference between the tripod shaft part 22 or the boss part 21 with the inside member 31. In the following, the axis of the inside member 31 means the axis of the through hole 31g of the inside member 31 unless otherwise specified.

As shown in FIG. 5 and FIG. 6, the inside member 31 includes a fitted part 35 having a non-cylindrical outer peripheral surface, and an arc groove 36 to which a snap ring 34 is fitted. The fitted part 35 has an inside member arc part 35a and a flat surface part 35b.

The inside member arc part 35a is an arc surface formed about the axis of the through hole 31g of the inside member 31. In short, the inside member arc part 35a is an outer peripheral surface formed by turning to a given depth d1 from the both end surfaces 31a, 31b sides with a given diameter φD2 while rotating the inside member 31 about the axis of the through hole 31g (see the sectional view in FIG. 7). At this time, the diameter φD2 is slightly larger than the length L1 of the long sides of the inside member 31. Therefore, the inside member arc part 35a is disconnected in the middles of the side surfaces 31c, 31d on the longs sides of the inside member 31 and the side surfaces 31e, 31f on the short sides. FIG. 6 shows a section of a portion where the inside member arc part 35a is disconnected. FIG. 7 shows a section of a portion where the inside member arc part 35a is not disconnected.

It is preferred that the given depth d1 shown in FIG. 7, with which the inside member arc part 35a is processed from the both end surfaces 31a, 31b sides, is positioned so as to be separated from each of the end surfaces 31a, 31b slightly more than a position P of the dent part, which is most separated from each of the end surfaces 31a, 31b. In the foregoing dent part, each of the tapered surfaces 31h, 31i and each of the side surfaces 31c, 31d intersect with each other, and the dent part is dented into a curved shape from each of the both end surfaces 31a, 31b, as shown in FIG. 4.

The flat surface part 35b shown in FIG. 5 is a portion of the fitted part 35 of the inside member 31, and is engaged in a circumferential direction with a flat surface part 37b of a fitting part 37 of the holding member 33 described in detail later. The flat surface part 35b is provided on the same plane as each of the side surfaces 31c, 31d of the inside member 31. As stated earlier, the flat surface part 35b and each of the side surfaces 31c, 31d are formed together by grinding. The flat surface part 35b is an outer peripheral surface formed on each of the side surfaces 31c, 31d in a case where it is assumed that end parts of the inside member arc part 35a provided on short sides of the inside member 31 are connected with each other through each of the side surfaces 31c, 31d. Flat surface-shaped rolling surface 38, which allows the rolling elements 32 to roll, is also provided on the same plane as the flat surface part 35b. In short, the flat surface-shaped rolling surface 38 is also a ground surface.

The arc groove 36, which is a groove with a given depth, is formed coaxially with an outer peripheral surface 35c from the arc-shaped outer peripheral surface 35c to a radially inner side of the outer peripheral surface 35c (see the broken line in FIG. 5, and FIG. 6). The center of arc of the arc groove 36 coincides with the axis of the through hole 31g of the inside member 31. As shown in FIG. 6, the outer peripheral surface 35c is an outer peripheral surface obtained by turning to a given depth d2 from each of the both end surfaces 31a, 31b sides. The outer peripheral surface 35c is formed about the axis of the through hole 31g so as to have a given diameter φD3. In short, the outer peripheral surface 35c having the diameter φD3 is coaxial with the inside member arc part 35a having the diameter φD2. Therefore, the arc groove 36 and the inside member arc part 35a, which are both coaxial with the outer peripheral surface 35c, are coaxial with each other.

In this embodiment, a relation of size between the diameter φD3 of the outer peripheral surface 35c in which the arc groove 36 is provided, and the diameter φD2 of the inside member arc part 35a is φD2>φD3. However, the invention is not limited to this form, and φD2=φD3 may be possible. According to the foregoing, the arc groove 36 formed from the outer peripheral surface 35c is disconnected in the part of the inside member 31, which intersects with the side surfaces 31c, 31d on the long sides, and does not become a circumferential groove (see the broken line in FIG. 5). In short, the groove for fitting the snap ring 34 is not formed as a circumferential groove having the entirely connected circumference, and the arc groove 36 is formed at two locations on the short sides of the inside member 31, or on both ends of the long sides.

In other words, within the outer peripheral surface 35c of the inside member 31, the arc grooves 36 at the two locations in the inside member 31 are provided in portions (short sides) in a phase that is different from portions (long sides) in a phase that faces the side surfaces 16b, 16c of the raceway groove 16. The phase stated above means a phase of the outer peripheral surface 35c in the circumferential direction. Therefore, it becomes possible to reduce the length L2 of the short sides of the inside member 31 having the side surfaces 31e, 31f, thereby reducing a size of the inside member 31.

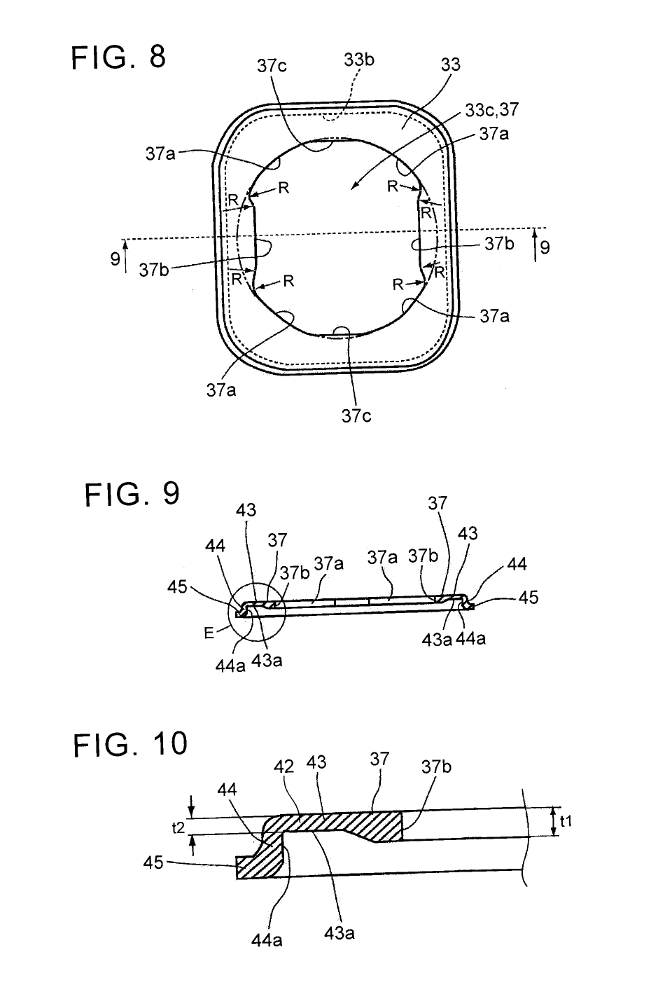

As shown in FIG. 8, the holding member 33 is formed into a rectangular shape from a plate-shaped member made from, for example, metal. The holding member 33 is formed into a ring shape having a space on an inner periphery side. The plate-shaped member is, for example, SPCC (JISG3141) that is a cold rolled steel sheet. The holding member 33 is formed by press forming of the plate-shaped member. However, the invention is not limited to this form, and the plate-shaped member may be other cold rolled steel sheet such as SPCD and SPCE. Also, other type of metal may be used. The holding member 33 is provided on the both end surfaces 31a, 31b sides in the axial direction of the through hole 31g of the inside member 31. Corner parts of the rectangular holding member 33 in a plan view are connected in a given radian The given radian may be set arbitrarily. The holding member 33 has the fitting part 37 and a rolling element abutment part 42.

In this embodiment, the fitting part 37 is a shear plane of pressing, which is obtained when the holding member 33 is formed by pressing. The fitting part 37 is a portion fitted to the fitted part 35 of the inside member 31. As shown in FIG. 8, the fitting part 37 is provided in a non-cylindrical inner peripheral surface 33c of the holding member 33. The fitting part 37 has holding member arc parts 37a at four locations (corresponding to a plurality of arc surfaces), and flat surface parts 37b at two locations. In this embodiment, the holding member arc parts 37a and the flat surface parts 37b are formed while maintaining a thickness of the plate member serving as the material for the holding member 33.

The holding member arc parts 37a are arc surfaces that are fitted (correspond) to the inside member arc parts 35a at four locations in the fitted part 35 of the inside member 31, respectively. Further, the flat surface parts 37b at two locations are flat surfaces that are fitted (correspond) to the flat surface parts 35b at two locations in the fitted part 35 of the inside member 31, respectively, and are engaged in the circumferential direction. In short, in a case where the holding member 33 is about to rotate relative to the inside member 31, the flat surface parts 35b at two locations in the inside member 31 relatively lock the flat surface parts 37b at two locations in the holding member 33 in the circumferential direction, thereby restricting the holding member 33 and the inside member 31 from rotating relatively with one another.

The fitted part 35 and the fitting part 37 may be fitted to each other by press-fitting, or with a small gap. In this embodiment, the fitted part 35 and the fitting part 37 are fitted with a small gap.

Among the holding member arc parts 37a at four locations in the holding member 33, the holding member arc parts 37a provided at two locations on each of the short sides of the rectangle are connected with each other by a straight part 37c that is in parallel to a straight part on each of the short sides of the rectangle. The straight part 37c faces each of the side surfaces 31e, 31f on the short sides of the inside member 31.

However, in this embodiment, in the case where the holding member 33 is about to rotate relative to the inside member 31, the holding member 33 and the inside member 31 are not in a dimensional relation that restricts relative rotation of the holding member 33 and the inside member 31 as the side surfaces 31e, 31f of the inside member 31 relatively lock the straight parts 37c of the holding member 33 in the circumferential direction, or the inside member arc parts 35a of inside member 31 relatively lock the straight parts 37c in the circumferential direction. However, the invention is not limited to this form. In the case where the holding member 33 is about to rotate relative to the inside member 31, relative rotation of the holding member 33 and the inside member 31 may be restricted as the side surfaces 31e, 31f relatively lock the straight parts 37c in the circumferential direction, or the inside member arc parts 35a of inside member 31 relatively lock the straight parts 37c in the circumferential direction. Each of the holding member arc parts 37a and the flat surface part 37b of the holding member 33 are connected with each other with a given radian shown in FIG. 8. The given radians may be set arbitrarily.

As shown in the sectional views in FIG. 9 and FIG. 10, the rolling element abutment part 42 includes an axial movement restricting part 43 and a radial movement restricting part 44. The axial movement restricting part 43 is formed so as to extend from the fitting part 37 to the radially outer side of the inside member 31. The axial movement restricting part 43 includes an axially restricting surface 43a on the rolling element 32 side. As shown in FIG. 10, a plate thickness t1 of the fitting part 37 is formed to be larger than a plate thickness t2 of the axial movement restricting part 43.

Specifically, the holding member 33 is formed so that a plate thickness increases from the axially restricting surface 43a to the fitting part 37 side towards a center part side of the rolling element 32. In FIG. 9 and FIG. 10, an upper side surface of the fitting part 37 and an upper side surface of the axial movement restricting part 43 are on the same plane. As shown in FIG. 4, the axially restricting surface 33a abuts on an end surface of a projection 41 (an end part) of the rolling element 32, thereby restricting the rolling element 32 from moving in the axial direction.

The radial movement restricting part 44 is formed by bending a portion on an outer periphery side of the axial movement restricting part 43 at, for example, the right angle towards the rolling element 32. The radial movement restricting part 44 includes a radially restricting surface 44a on the side of the projection 41 of the rolling element 32. As shown in FIG. 4, the radially restricting surface 44a abuts on a side surface of the projection 41 of the rolling element 32 and restricts the rolling element 32 from moving to the outer side of the inside member 31. As stated above, the rolling element abutment part 42 is provided along the entire circumference of the outer peripheral part of the holding member 33 so as to cover the projection 41 of the rolling element 32, or cover the axis of the rolling element 32.

The radial movement restricting part 44 also has a rib part 45 in a lower end part shown in FIG. 9 along the entire circumference of the outer peripheral part. The rib part 45 expands to the radially outer side of the holding member 33. Viewed from a direction shown in FIG. 3, the rib part 45 is provided so that a part of a cylindrical part 39 of each of the rolling elements 32 (explained later) is arranged on the outer periphery side of the outer periphery of the rib part 45. The plate thicknesses of the radial movement restricting part 44 and the rib part 45 of the radial movement restricting part 44 may be equal to the plate thickness t2 of the axial movement restricting part 43, or to the plate thickness t1 of the fitting part 37. In this embodiment, the plate thicknesses of the radial movement restricting part 44 and the rib part 45 of the radial movement restricting part 44 are a given plate thickness between the plate thickness t1 and the plate thickness t2.

The rolling element 32 includes the cylindrical part 39, and projections 41 (corresponding to end parts) that are formed coaxially with the center axis of the cylindrical part 39. The rolling element 32 is a shaft-shaped member. The projections 41 are provided so as to project from both ends of the cylindrical part 39, respectively. The cylindrical part 39 is formed into a cylinder shape, and is structured so that a cylinder diameter of the cylindrical part 39 (corresponding to a thickness of a center part of the rolling element in an axial direction of the inside member) is larger than a column diameter of the projection 41 (corresponding to a thickness of an end part in the axial direction).

As shown in FIG. 4, the rolling element 32 is a needle. As shown in FIG. 1 and FIG. 3, the plurality of rolling elements 32 are provided so as to circulate along the outer periphery of the inside member 31. Specifically, as stated earlier, the projections 41, 41 of the plurality of rolling elements 32 are supported by the rolling element abutment parts 42 of the holding members 33, 33 provided on the sides of the both end surfaces 31a, 31b in the axial direction of the inside member 31. To be in detail, the projections 41 on both ends of the rolling element 32 are supported by the axially restricting surfaces 43a, 43a and the radially restricting surfaces 44a, 44a of the holding members 33, 33 so as to be able to roll.

Some of the plurality of rolling elements 32 (six to seven in total in this embodiment) are provided so as to roll between each of the side surfaces 16b, 16c of the raceway groove 16, and each of the side surfaces 31c, 31d on the long sides of the inside member 31 along each of the side surfaces 16b, 16c, 31c, 31d. Rotational driving force is transmitted between each of the side surfaces 31c, 31d and the each of the side surfaces 16b, 16c of the raceway groove 16 through the rolling elements 32. In the side surfaces 31c, 31d of the inside member 31, flat surfaces provided so as to allow the rolling elements 32 to roll are referred to as flat surface-shaped rolling surfaces 38. This means that each of the side surfaces 31c, 31d and the flat surface-shaped rolling surface 38 are formed on the same surface. The flat surface part 35b of the fitted part 35 of the inside member 31 is also formed on the same surface as each of the side surfaces 31c, 31d. Thus, the flat surface-shaped rolling surface 38 and the flat surface part 35b of the fitted part 35 are also formed on the same surface.

The snap ring 34, which is a C-type snap ring having a cylinder-shaped inner peripheral surface, is fitted to the arc groove 36 (see FIG. 4). As shown in FIG. 4, an outer peripheral part of the snap ring 34 that is fitted to the arc groove 36 having the given depth sticks out from the outer peripheral surface 35c radially outwardly by a previously-set amount. The previously-set amount is provided so that the snap ring 34 extends to a position to cover an axis of at least one of the rolling elements 32 (or the projections 41) out of the rolling elements 32 arranged between each of the side surfaces 16b, 16c of the raceway groove 16 and each of the side surfaces 31c, 31d on the long sides of the inside member 31. In FIG. 3, the snap ring 34 is provided so as to cover an axis L of the rolling element 32 indicated by D. Thus, in collaboration with the axial movement restricting part 43 of the holding member 33, the snap ring 34 restricts the rolling element 32(D) from moving (falling out) in the axis L direction as the rolling element 32(D) receives great force due to transmission of rotational driving force.

Operations of the foregoing constant velocity joint 1 are explained. As stated above, in the constant velocity joint 1, the holding member arc part 37a of the fitting part 37 formed in the inner peripheral surface of the holding member 33 is fitted to the inside member arc part 35a of the fitted part 35 formed in the outer peripheral surface of the inside member 31 (see FIG. 5 and FIG. 8). As stated earlier, in this embodiment, the fitted part 35 and the fitting part 37 are fitted to each other, leaving a small gap in-between. The holding member arc part 37a and the inside member arc part 35a are formed so as to be coaxial with each other when fitted to each other. Therefore, fitting of the holding member arc part 37a and the inside member arc part 35a to each other is not sufficient to restrict and disable the holding member 33 from rotating relative to the inside member 31 about the axis of each of the arc parts 37a, 35a.

However, the fitted part 35 of the inside member 31 includes the flat surface part 35b having a non-cylindrical shape. Further, the fitting part 37 of the holding member 33 includes the flat surface part 37b that is fitted to the flat surface part 35b. Therefore, when the inside member 31 and the holding member 33 are about to rotate relative to each other about the axis of each of the arc parts 37a, 35a, the flat surface part 35b is relatively engaged with the flat surface part 37b in the circumferential direction, thereby restricting and disabling the holding member 33 from rotating relative to the inside member 31.

In the axial direction of the through hole 31g of the inside member 31, the snap ring 34 is provided on the opposite side of the inside member 31 with respect to the holding member 33 and fitted to the arc groove 36 that is formed in the outer peripheral surface 35c so that the snap ring 34 abuts on the surface of the holding member 33 on the opposite side of the inside member 31. Thus, the snap ring 34 restricts the holding member 33 from separating and falling off from the inside member 31 in the axial direction of the inside member 31.

According to the embodiment, the tripod constant velocity joint 1 is a so-called rolling element circulation type. Therefore, the rolling element 32 located on the opposite side of the power transmission side has small friction force against the raceway groove. Hence, resistance due to sliding friction between the rolling element 32 and the raceway groove 16 is greatly reduced. By fitting the fitting part 37 having the non-cylindrical inner peripheral surface in the holding member 33 to the fitted part 35 having non-cylindrical outer peripheral surface of the inside member 31, the holding member 33 is prevented from rotating relative to the inside member 31 simply while holding the rolling element 32 favorably. This means that the holding member 33 is restricted directly from rotating relative to the inside member 31. Therefore, unlike the prior art, it is not necessary to provide a wall part (a cover) in the holding member 33 and abut an inner periphery side surface of the wall part on an outer periphery side of the rolling element 32 in order to disable rotation of the holding member 33 relative to the inside member 31. Thus, the wall part of the holding member 33 is not arranged radially in line with the inside member 31 and the rolling element 32 to the radially outer side of the inside member 31. Hence, size and weight of the holding member 33 are reduced, thereby achieving downsizing and weight reduction of the constant velocity joint.

In the foregoing embodiment, since the arc groove 36 and the inside member arc part 35a are coaxial with each other, it is necessary to set a material for the inside member 31 in a lathe only once, and then the arc groove 36 and the inside member arc part 35a are turned without a set-up change thereafter. As a result, processing cost is reduced. Since the snap ring 34 is provided, the holding member 33 is fixed for retention more securely, thereby improving reliability.

According to the foregoing embodiment, the inner peripheral surface of the snap ring 34 has a cylinder shape, the inside member 31 only has the arc groove 36 as a groove for fitting the snap ring 34, and the arc groove 36 of the inside member 31 is provided in a portion of the outer peripheral surface of the inside member 31 in a phase that is different from a portion in a phase that faces the side surfaces 16b, 16c of the raceway groove 16.

As stated above, although the cylinder-shaped snap ring 34 is fitted, the groove in the inside member 31, to which the snap ring 34 is fitted, is not provided in the entire circumference, and is provided as the arc groove 36 only in the portion in the phase that is different from the portion in the phase that faces the side surfaces 16b, 16c of the raceway groove 16 in the circumferential direction. Therefore, of the width of the inside member 31, the width of the portion in the phase where the arc groove 36 is not provided is smaller than that in the case where the groove is provided in the entire circumference. Therefore, the size of the inside member 31 is reduced.

According to the foregoing embodiment, the non-cylindrical outer peripheral surface of the fitted part 35 of the inside member 31 has the flat surface part 35b, and the inside member 31 includes the flat surface-shaped rolling surface 38 that allows the rolling elements 32 to roll. The flat surface part 35b and the flat surface-shaped rolling surface 38 of the fitted part 35 are formed on the same plane. Therefore, the flat surface part 35b of the inside member 31, and the flat surface-shaped rolling surface 38 are formed at the same time by simple flat surface grinding, thereby reducing a cost.

According to the foregoing embodiment, the flat surface part 35b of the fitted part 35 of the inside member 31, and the flat surface-shaped rolling surface 38 of the inside member 31 are surfaces that face each of the side surfaces 16b, 16c of the raceway groove 16. Thus, the flat surface part 35b and the flat surface-shaped rolling surface 38 of the inside member 31 also work as transmission surfaces that transmit rotational driving force of the tripod shaft to the side surfaces 16b, 16c of the raceway groove 16 through the rolling elements 32. Therefore, it is not necessary to provide an additional transmission surface, and it is thus possible to obtain the transmission surface with good accuracy at low cost.

According to the foregoing embodiment, the inside member 31 is formed into the rectangular parallelepiped shape having two opposing pairs of parallel flat surfaces on the outer periphery. In the fitted part 35 of the inside member 31, the portion engaged with the fitting part 37 of the holding member 33 in the circumferential direction is provided in flat surfaces on the long sides (side surfaces 31c, 31d). The flat surfaces on the long sides are the pair of flat surfaces that are longer in the circumferential direction in the outer peripheral surface of the inside member 31, out of the two opposing pairs of flat surfaces of the inside member 31 having the rectangular parallelepiped shape. The flat surfaces on the long sides (side surfaces 31c, 31d) are surfaces that face the side surfaces 16b, 16c of the raceway groove 16, respectively.

As stated above, the portion of the fitted part 35, which is engaged with the fitting part 37 of the holding member 33 in the circumferential direction, is provided in the flat surfaces on the long sides (side surfaces 31c, 31d) of the inside member 31. Thus, the portion to be engaged becomes longer compared to a case where a portion to be engaged is provided in the flat surfaces on short sides (side surfaces 31e, 31f). Hence, the rotation of the holding member 33 relative to the inside member 31 in the circumferential direction is restricted highly accurately.

According to the foregoing embodiment, of the two opposing pairs of flat surfaces of the inside member 31 having the rectangular parallelepiped shape, the pair of flat surfaces on the long sides (side surfaces 31c, 31d) are ground surfaces, and the pair of flat surfaces on the short sides (side surfaces 31e, 31f) are non-ground surfaces. Thus, grinding is performed only on the flat surfaces on the long sides of the inside member, which require surface accuracy for transmitting rotational driving force and face the side surfaces of the raceway groove 16. Grinding is not performed on the flat surfaces on the short sides, which do not require highly accurate ground surfaces. Therefore, the inside member is obtained at low cost.

It is also necessary to prevent the inside member 31 from being inserted into the raceway groove 16 in a direction in which the non-ground flat surfaces (side surfaces 31e, 31f) face the side surfaces 16b, 16c of the raceway groove 16, in other words, a direction in which the non-ground flat surfaces (side surfaces 31e, 31f) become the power transmission surfaces. The inside member 31 has the rectangular parallelepiped shape in which the long sides are ground surfaces, and the short sides are non-ground surfaces. This means that, even if an operator tries to insert the inside member 31 to the raceway groove 16 so that the flat surfaces on the short sides (side surfaces 31e, 31f) face the side surfaces 16b, 16c of the raceway groove 16, it is not possible to insert the inside member 31 in the raceway groove 16. Therefore, it is ensured that the inside member 31 is assembled to the raceway groove 16 so that the long sides, which are the ground surfaces, face the side surfaces 16b, 16c of the raceway groove 16.

In the foregoing embodiment, the holding members 33 are provided on both end sides of the inside member 31 in the axial direction, respectively. Thus, the tripod constant velocity joint 1 includes the simple and inexpensive holding members 33 on both ends of the inside member 31, and the holding members 33 on both sides hold the rolling elements 32. Therefore, the shape of the inside member 31 becomes simple, thereby reducing costs for the inside member 31.

According to the foregoing embodiment, the rolling element abutment part 42 that holds the projections 41 (end parts) of the rolling elements 32 is provided in the outer peripheral part of the holding member 33. The plate thickness t1 of the fitting part 37 of the holding member 33 is larger than the plate thickness t2 of the axial movement restricting part 43 that is at least a part of the rolling element abutment part 42. Therefore, it is ensured that holding member 33 is fitted to the inside member 31 with strength ensured by the fitting part 37, while reducing a weight of the holding member 33 by the rolling element abutment part 42.

According to the foregoing embodiment, plate thickness t1 of the fitting part 37 of the holding member 33 is larger than the plate thickness t2 of the rolling element abutment part 42. Therefore, the fitting part 37 is fitted to the inside member 31 while ensuring strength by the plate thickness t1, and the weight of the rolling element abutment part 42 is reduced. Therefore, the weight of the holding member 33 is reduced, thereby reducing the weight of the constant velocity joint 1.

According to the foregoing embodiment, the holding member 33 is formed so that the plate thickness of the holding member 33 increases from the axially restricting surface 43a of the axial movement restricting part 43 to the fitting part 37 side towards the center part side of the rolling element 32. In short, the holding member 33 is formed so that the thickness of the fitting part 37 increases towards a gap made by a difference between the outer diameter of the cylindrical part 39 of the rolling element 32 and the outer diameter of the projection 41 of the rolling element 32. Therefore, compared to the case where the thickness t1 of the fitting part 37 increases to the opposite side of the rolling element 32, the length of the inside member 31 and the fitting part 37 in the axial direction is shorter when the inside member 31 and the fitting part 37 are assembled. Thus, both the size and weight of the tripod constant velocity joint 1 are reduced.

According to the foregoing embodiment, the rolling element abutment part 42 includes the radial movement restricting part 44 that is formed by bending the outer peripheral part of the axial movement restricting part 43 at the right angle towards the rolling element 32. The radial movement restricting part 44 restricts the rolling element 32 from moving to the radially outer side of the inside member 31. Therefore, it is possible to hold the rolling element 32 favorably by the rolling element abutment part 42.

According to the foregoing embodiment, the rib part 45 is provided in the end part of the radial movement restricting part 44. The rib part 45 expands in the outer peripheral direction. Thus, strength of the rolling element abutment part 42 is improved.

According to the foregoing embodiment, the arc groove 36 is provided in the outer peripheral surface of the inside member 31, and the snap ring 34 is fitted to the arc groove 36. The snap ring 34 restricts the holding member 33 from moving in the axial direction of the inside member 31 by abutting on the surface of the axial movement restricting part 43 on the opposite side of the rolling element 32 side. Thus, even if the rolling element 32 moves in the axial direction of the inside member 31 and presses the axial movement restricting part 43, the snap ring 34 receives pressure force from the rolling element 32. Therefore, it is possible to favorably hold the rolling element 32 in collaboration with the holding member 33.

According to the foregoing embodiment, the snap ring 34 abuts on the surface of the axial movement restricting part 43 on the opposite side of the rolling element 32 side at a position where the snap ring 34 covers the distal end of the projection 41 (end part) of at least one of the rolling elements 32 arranged so as to face the side surfaces 16b, 16c of the raceway groove 16, or covers the center axis of the rolling element 32. As stated above, the snap ring 34 is provided at a position where the snap ring 34 covers the axis of at least one of the rolling elements 32 arranged so as to face the side surfaces 16b, 16c of the raceway groove 16. This is because, among the plurality of rolling elements 32, the above-mentioned rolling elements transmit rotational driving force and large force could be applied in the axial direction on the side surfaces 16b, 16c of the raceway groove 16. Thus, even if the rolling element 32 moves in the axial direction of the inside member 31 and presses the axial movement restricting part 43 of the holding member 33 with large force, the snap ring 34, which is provided in the axial movement restricting part 43 on the opposite side of the rolling element 32, is able to receive the pressure force of the rolling element 32. Therefore, the snap ring 34 holds the rolling element 32 favorably. It is thus possible to reduce the plate thickness of the axial movement restricting part 43 further, and the weight of the holding member 33 is thus reduced further.

According to the foregoing embodiment, the holding member 33 is formed by pressing a plate member, and the fitting part 37 is a shear plane of pressing. Therefore, processing for the fitting part 37 is not necessary, thereby reducing the cost for the holding member 33.

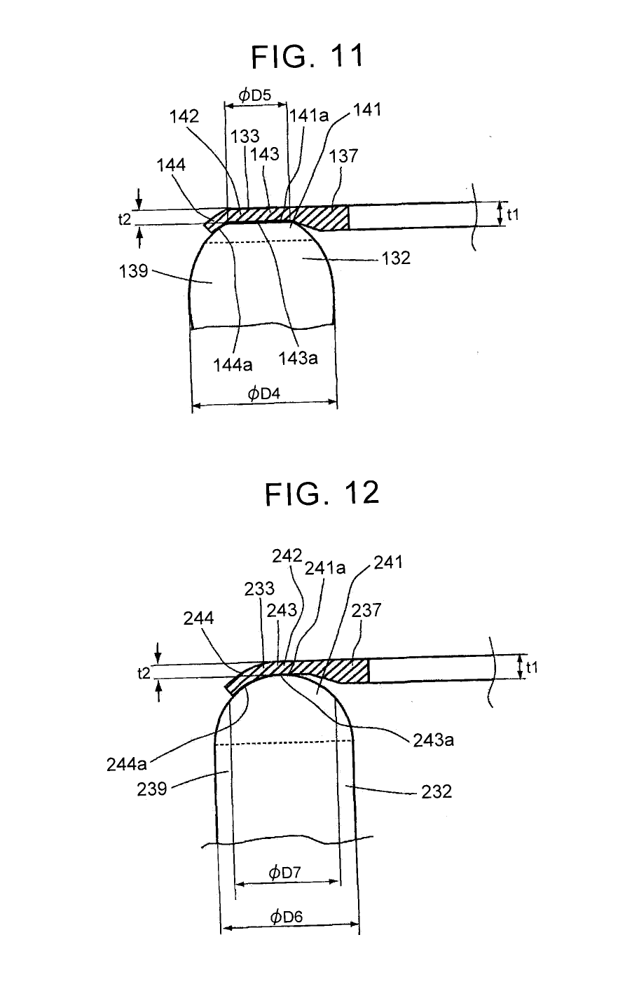

Next, the first modified example is explained. The first modified example is similar to the foregoing embodiment with an exception. Therefore, only the modification is explained, and detailed explanation of the similar parts is omitted. The similar components are denoted by the same reference numerals in the explanation. For the first modified example, only a relation between a holding member and rolling elements is explained. This applies to the second and third modified examples explained later. As shown in FIG. 11, the first modified example includes a holding member 133 and a rolling element 132. The rolling element 132 has a shaft shape. The rolling element 132 includes a barrel-shaped cylindrical part 139, in which a cylinder center part expands in the axial direction, and an end part 141 projecting in the axial direction of the cylindrical part 139 from an end surface of the cylindrical part 139 (see the broken line in FIG. 11). An end surface 141a of the end part 141, which is a flat surface, has a diameter φD5, and the end surface 141a is formed so that the diameter φD5 is smaller than an outer diameter φD4 (corresponding to the maximum outer diameter) of the cylinder center part of the cylindrical part 139.

The holding member 133 includes a fitting part 137 and a rolling element abutment part 142. The fitting part 137 is formed in an inner periphery part to have a non-cylindrical shape and a plate thickness t1. The rolling element abutment part 142 is formed in the outer peripheral part. The rolling element abutment part 142 abuts on the end surface 141a of the rolling element 132 and is formed to have at least partially a plate thickness t2 smaller than the plate thickness t1. The rolling element abutment part 142 includes an axial movement restricting part 143 and a radial movement restricting part 144. The axial movement restricting part 143 is formed so as to extend from the fitting part 137 radially outwardly. The axial movement restricting part 143 includes an axially restricting surface 143a on the rolling element 132 side. The plate thickness t2 of the axial movement restricting part 143 is formed to be smaller than the plate thickness t1 of the fitting part 137.

To be specific, the fitting part 137 is formed so that the thickness increases towards the center part side of the rolling element 132 with respect to the axially restricting surface 143a. In short, the fitting part 137 is formed so that the thickness of the fitting part 137 increases towards a gap made by a diameter difference between the outer diameter φD4 of the cylindrical part 139 and the diameter φD5 of the end surface 141a. An upper side surface of the fitting part 137 and an upper side surface of the axial movement restricting part 143 in FIG. 11 are the same surface. The axially restricting surface 143a abuts on the end surface 141a of the rolling element 132 and restricts the rolling element 132 from moving in the axial direction.

The radial movement restricting part 144 is formed by slightly bending a portion on an outer periphery side of the axial movement restricting part 143 towards the rolling element 132 side. The radial movement restricting part 144 includes a radially restricting surface 144a on the cylindrical part 139 side of the rolling element 132. The radially restricting surface 144a abuts on a side surface of the cylindrical part 139 of the rolling element 132, and restricts the rolling element 132 from moving radially outwardly.

This way, the rolling element abutment part 142 is provided in the entire circumference of the outer peripheral part of the holding member 133 so as to cover the end surface 141a (end part) of the rolling element 132, or cover the axis of the rolling element 132.

The plate thickness of the radial movement restricting part 144 may be equal to the plate thickness t2 of the axial movement restricting part 143 or equal to the plate thickness t1 of the fitting part 137. Because of this form, effects similar to those of the foregoing embodiment are obtained.

Next, the second modified example is explained. Similarly to the first modified example, the second modified example is similar to the foregoing embodiment with an exception. Therefore, only the modification is explained, and detailed explanation of the similar parts is omitted. The similar components are denoted by the same reference numerals in the explanation. As shown in FIG. 12, the second modified example includes a holding member 233 and a rolling element 232. The rolling element 232 has a shaft shape, and includes a cylindrical part 239 and an end part 241. The cylindrical part 239 is formed into a cylinder shape with a cylinder diameter (maximum diameter) of φD6 in an axial direction. The end part 241 is provided so as to project in the axial direction of the cylindrical part 239 from the end surface of the cylindrical part 239 (see the broken line in FIG. 12). The end part 241 has a spherical shape, and a diameter φD7 in a direction orthogonal to the axis is reduced as separated from the cylindrical part 239 in the axial direction. The end part 241 has an end surface 241a.

The holding member 233 includes a fitting part 237 and a rolling element abutment part 242. The fitting part 237 is formed in an inner peripheral part to have a non-cylindrical shape with a plate thickness t1. The rolling element abutment part 242 is formed in an outer peripheral part. The rolling element abutment part 242 abuts on the end surface 241a of the end part 241 of the rolling element 232 and is formed to have at least partially a plate thickness t2 that is smaller than the plate thickness t1. The rolling element abutment part 242 includes an axial movement restricting part 243 and a radial movement restricting part 244. The axial movement restricting part 243 is formed so as to extend radially outwardly from the fitting part 237. The axial movement restricting part 243 includes an axially restricting surface 243a on the rolling element 232 side. The plate thickness t2 of the axial movement restricting part 243 is formed to be smaller than the plate thickness t1 of the fitting part 237.

To be specific, the fitting part 237 is formed so that the thickness increases towards a center part side of the rolling element 232 with respect to the axially restricting surface 243a. In short, the fitting part 237 is formed so that the thickness of the fitting part 237 increases towards a gap made by a diameter difference between the outer diameter φD6 of the cylindrical part 239 and the diameter φD7 of the end part 241. An upper side surface of the fitting part 237 and an upper side surface of the axial movement restricting part 243 in FIG. 12 are at the same height. The axially restricting surface 243a formed into the spherical shape abuts on the end surface 241a of the rolling element 232 and restricts the rolling element 232 from moving in the axial direction.

The radial movement restricting part 244 also works as the axial movement restricting part 243. The radial movement restricting part 244 includes a radially restricting surface 244a on the side of the end surface 241a of the rolling element 232. The radially restricting surface 244a abuts on the end surface 241a and restricts the rolling element 232 from moving radially outwardly. Thus, the rolling element abutment part 242 is provided in the entire circumference of the outer peripheral part of the holding member 233 so as to cover the axis of the rolling element 232.

The plate thickness of the radial movement restricting part 244 may be equal to the plate thickness t2 of the axial movement restricting part 243 or equal to the plate thickness t1 of the fitting part 237. Because of this form, effects similar to those in the foregoing embodiment are obtained. In the first and second modified examples, a rib part is not provided in the radial movement restricting parts 144, 244. However, the invention is not limited to these forms, and the rib part may be provided when it is settable.

Next, as the third modified example that shows an example other than a shaft-shaped rolling element, the rolling elements 32, 132, 232 may be spherical (not shown). In this case, the example can be considered as a combination of the rolling element 132 of the first modified example and the rolling element 232 of the second modified example. With such a form, effects similar to those of the foregoing embodiment are also obtained.

In the foregoing embodiment and the first to third modified examples, the fitting part 37 of the holding member 33 and the fitted part 35 of the inside member 31 are fitted to each other with a gap in-between. However, the invention is not limited to this form. The fitting part 37 and the fitted part 35 may be fitted to each other by press-fitting. In this case, the snap ring 34 and the arc groove 36 may be or may not be provided. Adequate effects are still obtained.

In the foregoing embodiment and the first to third modified examples, the inside member 31 is inserted so that the side surfaces 31c, 31d on the long sides of the inside member 31 face the side surfaces 16b, 16c of the raceway grooves 16, respectively. However, the invention is not limited to this form, and the inside member 31 may be inserted so that the side surfaces 31e, 31f on the short sides of the inside member 31 face the side surfaces 16b, 16c of each of the raceway grooves 16, respectively. In this case, the side surfaces 31e, 31f on the short sides are ground surfaces, and the side surfaces 31c, 31d on the long sides are non-ground surfaces.

In the foregoing embodiment and the first to third modified examples, the inside member 31 is formed into the rectangular parallelepiped shape. However, the invention is not limited to this form, and the inside member 31 may be formed so that long sides and short sides have the same length. With this, it is still possible to obtain the effects of restricting relative rotation of the inside member 31 and the holding member 33 at low cost, because of the structure of the invention.

In the foregoing embodiment and the first to third modified examples, the side surfaces 31c, 31d on the long sides of the inside member 31 are ground surfaces. However, the invention is not limited to this form, and all of the side surfaces on the long sides and the short sides may be non-ground surfaces. With this, it is still possible to obtain adequate effects. All of the side surfaces on the long sides and the short sides may also be ground surfaces.

In the foregoing embodiment and the first to third modified examples, the flat surface part 35b of the fitted part 35 is provided in each of the side surfaces 31c, 31 d on the long sides of the inside member 31. However, the invention is not limited to this form, and the flat surface part 35b may also be provided in each of the side surfaces 31e, 31f on the short sides of the inside member 31.

In the foregoing embodiment and the first to third modified examples, the non-cylindrical outer peripheral surfaces of the fitted part 35 of the inside member 31, and of the fitting part 37 of the holding member 33 are formed by the flat surface parts 35b, 37b, respectively. However, the invention is not limited to this form. The non-cylindrical outer peripheral surfaces may be made in any shape other than the flat surfaces. With this, similar effects are still obtained.

In the foregoing embodiment and the first to third modified examples, the holding member 33 is provided on the sides of the both end surfaces 31a, 31b of the inside member 31. However, the invention is not limited to this form, and the holding member 33 may be provided either one of the both end surfaces 31a, 31b. In this case, in the other one of the end surfaces 31a, 31b, on which the holding member 33 is not provided, it is only necessary to provide a rib part, which corresponds to the holding member 33, integrally with the inside member 31. With this, effects for one holding member 33 are obtained.

In the foregoing embodiment and the first to third modified examples, the snap ring 34 and the arc groove 36 are provided so as to retain the holding member 33. However, the invention is not limited to this form. The holding member 33 may be retained by caulking the holding member 33, instead of using the snap ring 34.

What is claimed is:

1. A tripod constant velocity joint comprising:
an outer race having a tubular shape, in which a plurality of raceway grooves extending in a rotation axis direction of the outer race are formed in an inner peripheral surface of the outer race;
a tripod including a boss part coupled with a shaft, and a plurality of tripod shaft parts provided so as to extend to a radially outer side of the boss part from an outer peripheral surface of the boss part;
an inside member that is formed into a ring shape and provided in an outer periphery of the shaft part of the tripod so as to be able to tilt with respect to the shaft part of the tripod;
a plurality of rolling elements that are provided in an outer periphery of the inside member so as to be able to circulate, and are provided so as to be able to roll along a side surface of the raceway groove; and
a holding member that restricts the rolling elements from moving with respect to the inside member in an axial direction of the inside member and also restricts the rolling elements from moving with respect to the inside member to the radially outer side of the inside member, wherein
the inside member includes a fitted part having a non-cylindrical outer peripheral surface,
the holding member includes a fitting part that has a non-cylindrical inner peripheral surface and is fitted to the fitted part, and
the holding member is unable to rotate relative to the inside member as the fitted part and the fitting part are fitted to each other.

2. The tripod constant velocity joint according to claim 1, wherein
the tripod constant velocity joint includes a snap ring that restricts the holding member from moving in the axial direction of the inside member,
the inside member has an arc groove on the outer peripheral surface, to which the snap ring is fitted,
the non-cylindrical outer peripheral surface of the fitted part of the inside member has an inside member arc part,
the non-cylindrical inner peripheral surface of the fitting part of the holding member has a holding member arc part corresponding to the inside member arc part of the fitted part, and
the arc groove and the inside member arc part are formed coaxially with each other.

3. The tripod constant velocity joint according to claim 2, wherein
an inner peripheral surface of the snap ring has a cylinder shape, and
the arc groove of the inside member is provided in a portion in a phase of the outer peripheral surface of the inside member in the circumferential direction, the portion in the phase being different from a portion in a phase that faces the side surface of the raceway groove.

4. The tripod constant velocity joint according to claim 1, wherein
the non-cylindrical outer peripheral surface of the fitted part of the inside member has a flat surface part,
the inside member has a flat surface-shaped rolling surface that allows the rolling elements to roll, and
the flat surface part of the fitted part and the flat surface-shaped rolling surface are formed on a same plane.

5. The tripod constant velocity joint according to claim 4, wherein
the flat surface part of the fitted part of the inside member, and the flat surface-shaped rolling surface of the inside member are surfaces that face the side surface of the raceway groove.

6. The tripod constant velocity joint according to claim 1, wherein
the inside member is formed into a rectangular parallelepiped shape with two opposing pairs of parallel flat surfaces in an outer periphery, and the two pairs of flat surfaces include a pair of flat surfaces on long sides where sides in the circumferential direction are longer, and a pair of flat surfaces on short sides where sides in the circumferential direction are shorter than the sides of the flat surfaces on the long sides,
a portion of the fitted part of the inside member, which is engaged with the fitting part of the holding member in the circumferential direction, is provided in the flat surfaces on the long sides of the inside member, and
the flat surfaces on the long sides are surfaces facing the side surfaces of the raceway groove.

7. The tripod constant velocity joint according to claim 6, wherein
the pair of flat surfaces on the long sides of the inside member having the rectangular parallelepiped shape are ground surfaces, and
the pair of flat surfaces on the short sides are non-ground surfaces.

8. The tripod constant velocity joint according to claim 1, wherein
the holding member is provided on both end sides of the inside member in the axial direction.

9. The tripod constant velocity joint according to claim 1, wherein
the holding member is formed into a ring plate shape, and a rolling element abutment part that abuts on an end part of the rolling element is provided in an outer peripheral part of the holding member, and
a plate thickness of the fitting part of the holding member is larger than at least a part of a plate thickness of the rolling element abutment part.

10. The tripod constant velocity joint according to claim 9, wherein
the rolling element has a shaft shape, and includes a cylindrical part, and the end part projecting from an end surface of the cylindrical part in a central axis direction of the cylindrical part,
the rolling element abutment part of the holding member includes an axial movement restricting part that is formed to the radially outer side of the inside member from the fitting part of the holding member, and has an axially restricting surface that restricts the rolling element from moving with respect to the inside member in the axial direction of the inside member by abutting on a distal end of the end part of the rolling element,
a maximum outer diameter of the cylindrical part of the rolling element in the axial direction of the inside member is larger than an outer diameter of the end part, and
a plate thickness of the holding member increases from the axially restricting surface towards the fitting part side in a direction to a center part of the rolling element.

11. The tripod constant velocity joint according to claim 10, wherein
the holding member for the rolling element includes a radial movement restricting part that is formed by bending an outer peripheral part of the axial movement restricting part in a direction to the rolling element, and restricts the rolling element from moving to the radially outer side of the inside member.

12. The tripod constant velocity joint according to claim 11, wherein
a rib part, which expands to a radially outer side of the holding member, is provided in an end part of the radial movement restricting part.

13. The tripod constant velocity joint according to claim 10, wherein
the inside member has a snap ring groove in the outer peripheral surface, and a snap ring is fitted to the snap ring groove, the snap ring abutting on a surface on the opposite side of the axially restricting surface of the axial movement restricting part, and restricting the holding member from moving in the axial direction of the inside member.

14. The tripod constant velocity joint according to claim 13, wherein
the snap ring covers a center axis of the cylindrical part of at least one of the rolling elements out of the plurality of rolling elements arranged so as to face the side surface of the raceway groove.

15. The tripod constant velocity joint according to claim 9, wherein
the fitting part of the holding member is formed from a plurality of arc surfaces, and the plurality of arc surfaces are coaxial with each other.

16. The tripod constant velocity joint according to claim 9, wherein
the holding member is formed by pressing a plate member, and
the fitting part of the holding member is a shear plane of pressing.
